(19) United States
(12) Patent Application Publication
(10) Pub. No.: US 2009/0139233 A1
(43) Pub. Date: Jun. 4, 2009

(54) ENVIRONMENTAL PROTECTED POWER GENERATING SYSTEM

(76) Inventor: Wen-Chang Lin, Kaohsiung County (TW)

Correspondence Address: Wen-Chang Lin, 235 Chung - Ho, Box 8-24, Taipei, TW

(21) Appl. No.: 11/947,761

(22) Filed: Nov. 29, 2007

(51) Int. Cl. F03G 6/06

(52) U.S. Cl. 60/641.15

(57) ABSTRACT

A power generating system comprises a water supply system for supplying water; a solar heating device having a water inlet and a water outlet; the water inlet being connected to the water supply system; the solar heating device receiving water from the water supply system and then the water being preheated in the solar heating device; a steam generating device connected to the water outlet of the solar heating device for storing hot water preheated from the solar heating device; a hydrogen-fuel generating device for electrolyzing water into hydrogen and oxygen as fuels; a combustion heating device for reheating hot water from the steam generating device; the fuel of the combustion heating device being hydrogen and oxygen from the hydrogen-fuel generating device; and a steam electric-power generator receiving steam from the steam generating device for generating electric power and then the electric power being outputted.

### FIELD OF THE INVENTION

The present invention relates to a power generating system, and particularly to an environmental protected power generating system, in that hydrogen, oxygen, and solar energy are used as fuels for heating water into steam so as to drive a load or a steam generating device. Furthermore, the present invention is matched to the requirement of environmental protection.

### BACKGROUND OF THE INVENTION

Currently, most the fuels from generating electric power are coals, petroleum, gas, or uranium, etc. These fuels can not be reused and thus they will be exhausted one day. Furthermore, these fuels will have great affects to air pollution and thus is harmful to environments.

Therefore, there is an eager demand for a novel way for generating electric power from reusing fuels, such as solar energy, hydrogen and oxygen, etc.

### SUMMARY OF THE INVENTION

Accordingly, the primary object of the present invention is to provide an environmental protected power generating system, in that hydrogen, oxygen, and solar energy are used as fuels for heating water into steam so as to drive a load or a steam generating device. Furthermore, the present invention is matched to the requirement of environmental protection.

To achieve above objects, the present invention provides a power generating system, comprising: a water supply system for supplying water; a solar heating device having a water inlet and a water outlet; the water inlet being connected to the water supply system; the solar heating device receiving water from the water supply system and then the water being preheated in the solar heating device by using solar energy collector of the solar heating device; a steam generating device connected to the water outlet of the solar heating device for storing hot water preheated from the solar heating device; a hydrogen-fuel generating device for electrolyzing water into hydrogen and oxygen as fuels; and a combustion heating device for reheating hot water from the steam generating device; the fuel of the combustion heating device being hydrogen and oxygen from the hydrogen-fuel generating device;

a steam electric-power generator receiving steam from the steam generating device for generating electric power and then the electric power being outputted to supply to a load or the hydrogen-fuel generating device for electrolyzing.

The various objects and advantages of the present invention will be more readily understood from the following detailed description when read in conjunction with the appended drawing.

### BRIEF DESCRIPTION OF THE DRAWINGS

FIG. 1 is a system block diagram of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

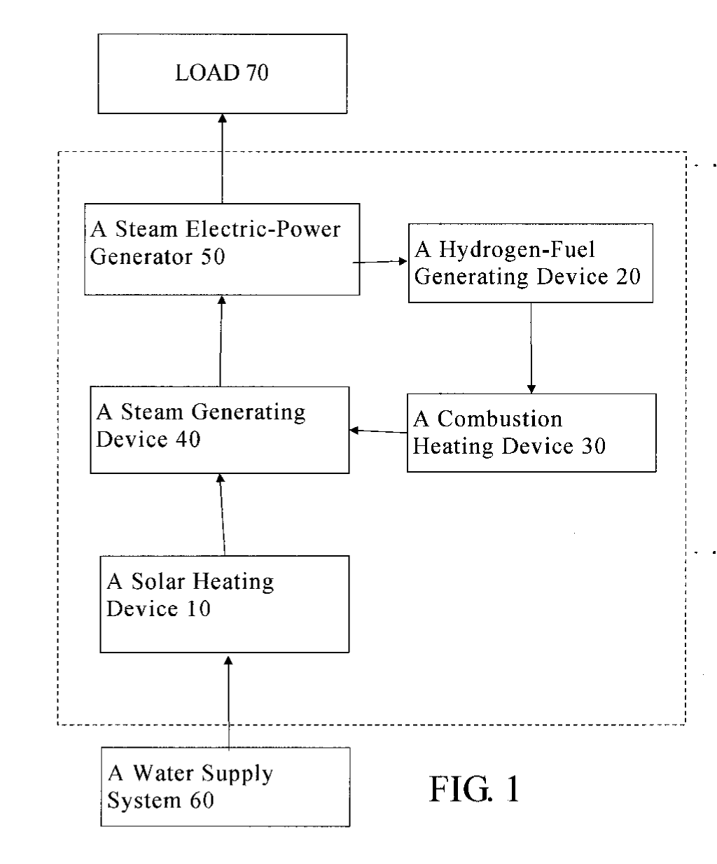

Referring to FIG. 1, the energy system of the present invention has the following elements.

A water supply system 60 serves for supplying water.

A solar heating device 10 has a water inlet and a water outlet. The water inlet is connected to the water supply system 60 and the water outlet is connected to a steam generating device 40. The solar heating device 10 receives water from the water supply system 60 and then the water is preheated in the solar heating device 10 by using solar energy collector in the solar heating device 10.

A steam generating device 40 is connected to the water outlet of the solar heating device 10 for storing hot water which is preheated from the solar heating device 10.

A hydrogen-fuel generating device 20 uses water as fuel. The water is electrolyzed into hydrogen and oxygen as fuels.

A combustion heating device 30 serves for reheating hot water from the steam generating device 40. The fuel of the combustion heating device 30 is hydrogen and oxygen from the hydrogen-fuel generating device 20.

A steam electric-power generator 50 receives steam from the steam generating device 40 for generating electric power and then the electric power is outputted to supply to the load 70 (such as an electric device) and moreover, the electric power can be supplied to the hydrogen-fuel generating device 20 for electrolyzing.

Thus it is known from above description that in the present invention, solar energy, hydrogen, and oxygen are used as fuels for heating water in the solar heating device and steam generating device. The fuels are harmless, odorless, colorless, and poisonless. They are easily bruned but generating no carbon so that it will not affect the temperature of the Earth.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An environmental protected power generating system, comprising:
a water supply system for supplying water;
a solar heating device having a water inlet and a water outlet; the water inlet being connected to the water supply system; the solar heating device receiving water from the water supply system and then the water being preheated in the solar heating device by using solar energy collector of the solar heating device;
a steam generating device connected to the water outlet of the solar heating device for storing hot water preheated from the solar heating device;
a hydrogen-fuel generating device for electrolyzing water into hydrogen and oxygen as fuels;
a combustion heating device for reheating hot water from the steam generating device; the fuel of the combustion heating device being hydrogen and oxygen from the hydrogen-fuel generating device; and
a steam electric-power generator receiving steam from the steam generating device for generating electric power and then the electric power being outputted to supply to a load or the hydrogen-fuel generating device for electrolyzing.
